(19) United States
(12) Patent Application Publication
(10) Pub. No.: US 2006/0129382 A1
(43) Pub. Date: Jun. 15, 2006

(54) Adaptive intrusion detection for autonomic systems

(76) Inventors: Vaijayanthimala K. Anand, Austin, TX (US); Sandra K. Johnson, Austin, TX (US); Kimberly D. Simon, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/351,062

(22) Filed: Feb. 9, 2006

Related U.S. Application Data
(63) Continuation of application No. 10/865,697, filed on Jun. 10, 2004.

(51) Int. Cl. G06F 17/27

(52) U.S. Cl. 704/9

(57) ABSTRACT

A system, method, and computer program product for adaptively identifying unauthorized intrusions in a networked data processing system. In accordance with the method of the present invention, an intrusion detection module receives system event data that may be utilized for intrusion detection. The received system event data is processed utilizing multiple intrusion detection techniques including at least one behavior-based intrusion detection technique to generate an intrusion detection result. In response to the intrusion detection result indicating an unauthorized intrusion, at least one knowledge-based intrusion detection corpus is updated utilizing the system event data. In a preferred embodiment, the intrusion detection system/method is implemented in a network data processing environment in which the knowledge-based intrusion detection corpus is communicatively accessible by multiple elements coupled to the networked data processing system. The method preferably includes issuing a network update to update knowledge-based intrusion detection corpora associated with the multiple elements included in the network.

### CROSS-REFERENCE TO RELATED APPLICATIONS

The present application is related to and claims the benefit of co-pending U.S. patent application Ser. No. 10/865,697, filed on Jun. 10, 2004, titled “SYSTEM AND METHOD FOR INTRUSION DECISION-MAKING IN AUTONOMIC COMPUTING ENVIRONMENTS,” which is incorporated herein by reference in its entirety.

### BACKGROUND OF THE INVENTION

1. Technical Field

The present invention relates generally to the field of computer security, and more particularly to an improved intrusion detection system (IDS) designed for use in an autonomic computing environment.

2. Description of the Related Art

The rapid growth in the number and type of computing devices and the proliferation of network-based applications have greatly expanded accessibility to systems and information. Unprecedented system complexity continually generates new demands for how to manage and maintain computer systems. Omnipresent accessibility to systems and data through personal computers, hand-held and wireless devices, etc., has placed large-scale systems and data at extreme risk of access and harm by malicious users. To address the threat of intrusion, most network system administrators invest substantial labor hours and equipment into intrusion detection systems. However, system complexity is reaching a level beyond human ability to manage and secure.

The growing complexity of modern networked computer systems is currently the most significant factor limiting their expansion. The increasing heterogeneity of large-scale computer systems, the inclusion of mobile computing devices, and the combination of different networking technologies such as wireless local area network, cellular phone networks, and mobile ad hoc networks make conventional, manual management very difficult, time-consuming, and error-prone.

Self-managed systems are being developed to address the foregoing issues. Self-management is the process by which computer systems manage their own operation with minimal human intervention. Self-management technologies such as those developed in accordance with the Autonomic Computing Initiative (ACI) are expected to pervade the next generation of network management systems.

Among the most important considerations in realizing self-management as defined by autonomic computing systems or otherwise is a system's ability to self-protect. Generally speaking, self-protection entails proactive identification and protection from arbitrary attacks from within or outside the network environment in question. Often comprising several interconnected heterogeneous elements, an autonomic computing environment presents many challenges for accurately determining what constitutes an unauthorized intrusion.

In this context, an intrusion includes actions and effects that intentionally or unintentionally compromise the integrity, availability, and/or confidentiality of computing resources. The performance of intrusion detection systems is typically characterized by performance metrics such as frequency of false positives (erroneous flagging of non-intrusion activity as an intrusion) and false negatives (undetected intrusions).

The two most common intrusion detection models are knowledge-based and behavior-based detection. The knowledge-based paradigm, such as that implemented by so-called signature-based systems, depends on the intrusion detection system (IDS) having knowledge of suspicious activity and investigating and detecting system event information that correlates with such knowledge. This knowledge is typically represented as a set of signatures, each encapsulating representative features of a variety of attacks or classes of attacks. The primary advantage of this model is that the frequency of false positive detections is relatively low and can be reduced by strengthening each signature by specifying attack features in greater detail. A drawback of knowledge-based detection, however, is that the frequency of false negative detections may be high, depending on the comprehensiveness and update status of the available signature knowledge base. Substantial user intervention is required to periodically update the signature knowledge base, further departing from the increasingly desirable self-managing security model.

The other common intrusion detection approach is behavior-based detection. In this paradigm, such as that implemented by so-called anomaly detection systems, the system has knowledge of normal operating behavior and investigates and detects activity outside a given behavior expectation threshold. Metrics defining “normal” or non-intrusion behavior are typically recorded during routine system operation. The main advantage of the behavior-based approach is the potentially lower susceptibility to false negatives or “misses,” which can be further reduced by lowering the behavior expectation thresholds. Unlike the knowledge-based approach, the behavior-based approach can potentially identify previously unidentified intrusions.

The main disadvantage of behavior-based intrusion detection is the relatively high frequency of false positive detections, since much “abnormal” behavior does not necessarily result from an intrusion.

A method and system for intrusion detection particularly well-suited for an autonomic computing environment is disclosed in a related, co-pending U.S. patent application Ser. No. 10/865,697 titled “SYSTEM AND METHOD FOR INTRUSION DECISION-MAKING IN AUTONOMIC COMPUTING ENVIRONMENTS,” filed on Jun. 10, 2004, and incorporated by reference herein in its entirety. The disclosed system addresses problems associated with aforementioned knowledge-based and behavior-based intrusion detection methods, and in particular, the inflexibility of such detection techniques as applied in an autonomic environment. Specifically, the disclosed intrusion detection method begins with a step of receiving system behavior event information. Multiple intrusion detection analyses are performed with respect to the received event information and the results are utilized to generate an intrusion detection determination in which behavior-based detection results are combined with knowledge-based detection results to determine a cumulative score which is utilized to identify the event as an intrusion or non-intrusion.

While the invention disclosed by U.S. patent application Ser. No. 10/865,697 provides an adaptive methodology for detecting previously unaccounted for intrusion mechanisms, a need remains for a method, system, and computer program product for further developing and implementing adaptive intrusion detection in an autonomic computer system. The present invention addresses this and other needs unresolved by the prior art.

### SUMMARY OF THE INVENTION

A system, method, and computer program product for adaptively identifying unauthorized intrusions in a networked data processing system are disclosed herein. In accordance with the method of the present invention, an intrusion detection module receives system event data that may be utilized for intrusion detection. The received system event data is processed utilizing multiple intrusion detection techniques including at least one behavior-based intrusion detection technique to generate an intrusion detection result. In response to the intrusion detection result indicating an unauthorized intrusion, at least one knowledge-based intrusion detection corpus is updated utilizing the system event data. In a preferred embodiment, the intrusion detection system/method is implemented in a network data processing environment in which the knowledge-based intrusion detection corpus is communicatively accessible by multiple elements coupled to the networked data processing system. The method preferably includes issuing a network update to update knowledge-based intrusion detection corpora associated with the multiple elements included in the network.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates a high-level block diagram representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 is a block diagram illustrating an adaptive intrusion detection system that may be implemented by the networked data processing systems shown in FIGS. 1-3 in accordance with the present invention; and

FIG. 5 is a flow diagram depicting steps performed during adaptive intrusion detection within an autonomic network environment in accordance with the present invention.

### DETAILED DESCRIPTION OF ILLUSTRATIVE EMBODIMENT(S)

The present invention provides a method, system and computer program product for performing intrusion decision-making using a plurality of approaches in an autonomic computing environment. As explained in further detail below with reference to the figures, the invention facilitates faster and more informed responses to intrusions by elements in an autonomic computing environment. In the absence of the present invention, network elements are susceptible to expending duplicate processing effort to make decisions when one element in the autonomic computing environment may have already completed the necessary intrusion analysis. By facilitating greater sharing of intrusion related data the present invention reduces the likelihood of virus “infections” or other malicious consequences of unauthorized intrusions.

In general, the devices that may comprise or relate to the present invention include a wide variety of data processing technology. Therefore, as background, a typical organization of hardware and software components within a distributed data processing system is described prior to explaining the present invention in more detail.

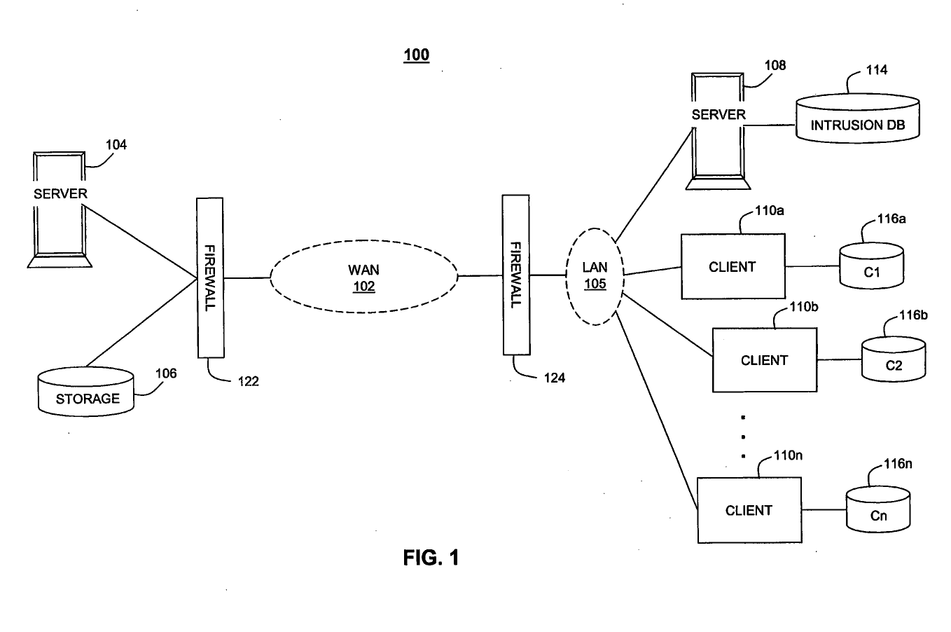

The data processing device may be a stand-alone computing device or may be a distributed data processing system in which multiple computing devices are communicatively interconnected and utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, wherein like reference numerals refer to like and corresponding parts throughout, and in particular with reference to FIG. 1, there is depicted a block diagram representation of a network of data processing system in which the present invention may be implemented. Network data processing system 100 generally comprises a wide area network (WAN) 102 including the physical and logical connectivity utilized to provide communications links between various devices and computers connected together within the network. In the depicted example, WAN 102 may be the Internet, representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, a network data processing system adapted for implementing the present invention may also be any one of a number of different types of networks, such as for example, an intranet, a local area network (LAN), or a wide area network (WAN). FIG. 1 is intended as an example, and not as an architectural limitation for the present invention.

WAN 102 may include hardware connectivity, such as provided by wire or fiber optic cables, as well as logical/signal-based connectivity, such as may be provided via packet switched and wireless communications architectures. In the depicted example, multiple servers 104 and 108 are communicatively coupled to clients 110a-110n as well as a storage device 106 via a local area network (LAN) 105 as well as WAN 102. Clients 110a-110n and servers 104 and 108 may be represented by a variety of program instructions, modules, and applications running on a variety of computing devices, such as mainframes, personal computers, personal digital assistants (PDAs), etc.

In the depicted example, server 104 is communicatively coupled to WAN 102 and storage device 106. Server 108 and multiple clients 110a-110n are mutually interconnected and coupled to WAN 102 via LAN 105. Clients 110a-110n may be, for example, any combination of client software and programs run on personal or network computers. In the depicted example, servers 104 and 108 may provide data, such as boot files, operating system images, and applications to clients 110a-110n. Clients 110a-110n may communicate requests to server 104 and/or server 108. Network data processing system 100 may include additional servers, clients, and other devices not shown in the depicted embodiment.

All or a portion of the devices in network data processing system 100 may be protected by a firewall, such as one of firewalls 122 and 124. A firewall is a mechanism for implementing security policies designed to keep a network or stand-alone system secure from intruders. A firewall may be implemented as a single router that filters out unwanted packets or may comprise a combination of routers and servers each performing some type of firewall processing. Specifically, firewalls 122 and 124 generally comprise hardware and/or software which function in a networked environment such as network data processing system 100 to detect and block network communications that violate an underlying security policy. The basic function of a firewall, such as firewalls 122 and 124, is to control network traffic among different zones of trust. Assuming WAN 102 represents the Internet, for example, the object zones of trust would include the Internet (a no-trust zone) and a higher threshold of trust presumably required by server 104 and LAN 105.

Firewalls are widely used to provide secure access to the Internet as well as to separate a company's public Web server from its internal network. Firewalls are also used to keep internal network segments secure. For example, an accounting network might be vulnerable to snooping from within the enterprise. In practice, many firewalls have default settings that provide little or no security unless specific policies are implemented by trained personnel. Firewalls installed to protect entire networks are typically implemented in hardware; however, software firewalls are also available to protect individual workstations from attack. Firewalls, also referred to in the art as packet filters or simply filters, are well-known in the art of network security and the details of implementing firewalls are therefore not discussed in detail herein.

In a preferred embodiment, network data processing system 100 is an autonomic computing environment in which all or a portion of the constituent devices and nodes are self-managing and include processing and instruction means in accordance with the present invention for enhanced self-protection from unauthorized intrusions. The present invention may be implemented on a variety of hardware platforms. FIG. 1 is intended as an example of a heterogeneous computing environment and not as an architectural limitation for the present invention.

Knowledge-based intrusion detection (ID) systems apply the data accumulated about specific attacks and system vulnerabilities. A knowledge-based intrusion detection system (IDS) contains signature information about these attacks and vulnerabilities and implements detection schemes for detecting intrusions that match the signature information. In this ID mode, any action or event that is not explicitly recognized as an attack is assumed safe. Therefore, knowledge-based systems have relatively high accuracy in terms of low rates of false alarms. However, the comprehensiveness of knowledge-based systems (i.e. the range of detection considering all possible attacks) is dependent on regular updates to the body of intrusion identification data.

Behavior-based intrusion detection techniques assume that an intrusion can be detected by observing a deviation from normal or expected behavior of the system or the users. The model of normal or valid behavior is extracted from reference information collected by various means. The intrusion detection system later compares this model with the current activity. When a deviation is observed, an alarm is generated. In other words, anything that does not correspond to a previously learned behavior is considered intrusive. Therefore, the intrusion detection system might be complete (i.e. all attacks should be caught), but its accuracy is a difficult issue (i.e. you get a lot of false alarms).

Advantages of behavior-based approaches are that they can detect attempts to exploit new and unforeseen vulnerabilities. They may also contribute to the detection and identification of these new attacks. They are less dependent on operating system-specific mechanisms. They also help detect ‘abuse of privileges’ types of attacks that do not actually involve exploiting any security vulnerability. In short, this is the paranoid approach: everything which has not been seen previously is assumed to be an unauthorized intrusion.

The high false alarm rate is generally cited as the main drawback of behavior-based techniques because the entire scope of the behavior of an information system may not be covered during the learning or training phase. Also, system behavioral tendencies often evolve over time, introducing the need for periodic online retraining of the behavior profile, resulting either in unavailability of the intrusion detection system or in additional false alarms. The information system can undergo attacks at the same time the intrusion detection system is learning the behavior. As a result, the behavior profile contains intrusive behavior, which is not detected as anomalous.

As explained in co-pending U.S. patent application Ser. No. 10/865,697, titled “SYSTEM AND METHOD FOR INTRUSION DECISION-MAKING IN AUTONOMIC COMPUTING ENVIRONMENTS,” one aspect of the present invention is utilizing multiple intrusion detection analyses to determine whether event information is indicative of an unauthorized intrusion. These intrusion detection analyses preferably include at least one knowledge-based and at least one behavior-based detection method.

One type of knowledge-based detection method is known as signature-based detection and uses a predefined event pattern to map to a known intrusion. Patterns usually lie within auditing events of a system, such as logs or records. Traditionally, these patterns are generated by a developer or system administrator to evaluate network traffic.

Scan-based ID is another form of knowledge-based ID technique that includes searching for suspicious scans that occur outside of a firewall to gain knowledge about various resources, such as what ports are available. Viruses, and in particular worms, seek to propagate by discovering vulnerabilities of other devices to which a device may be communicatively connected. Therefore, a scan-based IDS may identify pre-attack scanning or reconnaissance activity before a potential intrusion occurs, rather than waiting for the intrusion itself for detection. A well-configured firewall, such as one of firewalls 122 or 124, may utilized scan-based ID to prevent many scan-based attacks.

Anomaly-based ID is a type of behavior-based approach that uses a “baseline” in which complete knowledge of “self” or expected behavior is used to detect intrusions. Any deviations from this “baseline” of expected behavior is declared to be abnormal. The baseline may be gathered during a training or tuning phase. Traffic to and from a system or network may be gathered, analyzed, and stored.

A fairly recent behavior-based ID approach being investigated is danger theory. In the danger theory approach, a system may react to foreign substances or activities based on various danger signals. Once a foreign substance enters a system, a danger response is activated. Upon a danger response, a danger zone is used to surround the foreign substance. Sensors are created in the danger zone and the sensors are notified if a danger signal indicates a strong possibility of a malicious intrusion.

The danger theory approach may help alleviate the problem of “non-self but harmless” and “self but harmful” intrusions that may be missed by anomaly-based approaches. Danger theory may also address the fact that not all foreign activities will trigger a reaction. Discrimination between “self” and “non-self” may still be used in danger theory, but this discrimination is not required.

As explained in further detail below, the IDS of the present invention preferably uses multiple ID approaches, such as, for example, a combination of two or more of the above approaches, to identify malicious activity. When system event data is received, each ID method generates a result. The individual ID results are collectively processed and a consensus of the results is then reached using a statistical filtering technique, such as, for example, Bayesian filtering.

The intrusion detection mechanism of the present invention may be implemented by one or more devices within network data processing system 100. For example, one or both of firewalls 122, 124 may include an intrusion detection mechanism. In an autonomic computing environment, each device is preferably self-securing and employs the method and system features disclosed and described herein.

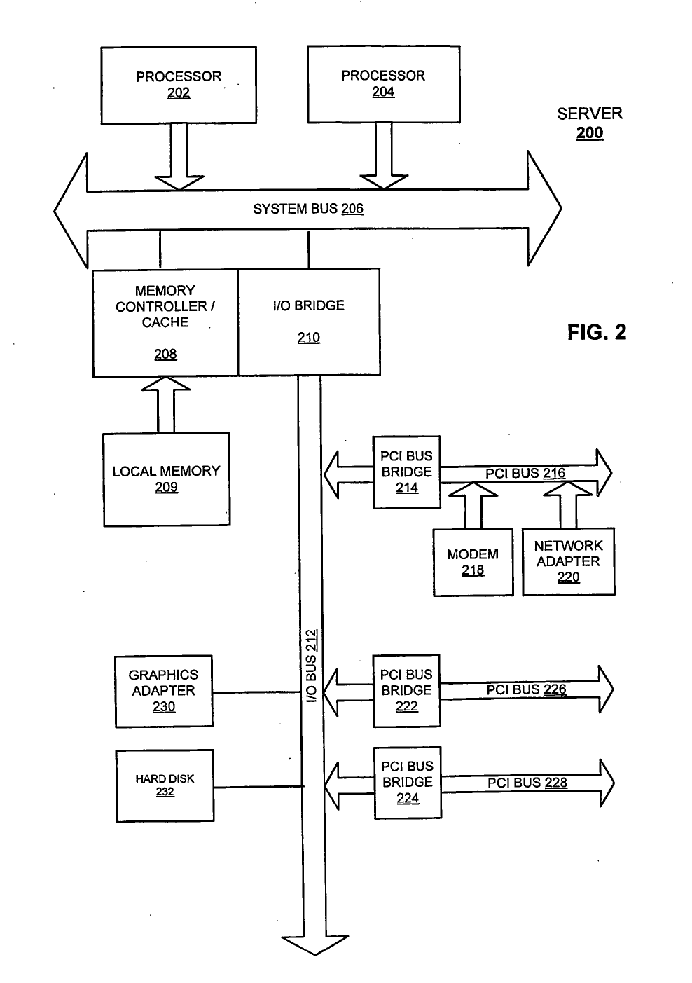

FIG. 2 illustrates a block diagram of a data processing system that may be implemented as a server, such as server 104 and/or server 108 in FIG. 1, in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 110a-110n in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX operating system.

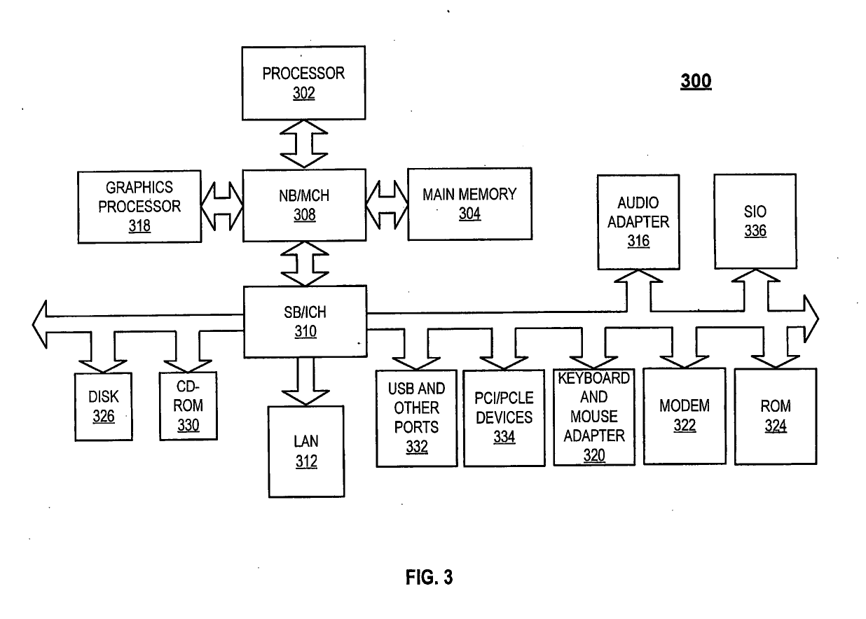

With reference now to FIG. 3, a block diagram of a data processing system is shown in which the present invention may be implemented. Data processing system 300 is an example of a computer, such as one or more of clients 110a-110n in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, LAN adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP®, which is available from Microsoft Corporation. An object oriented programming system, such as the Java® programming system, may run in conjunction with the operating system and provides calls to the operating system from Java® programs or applications executing on data processing system 300.

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

For example, data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

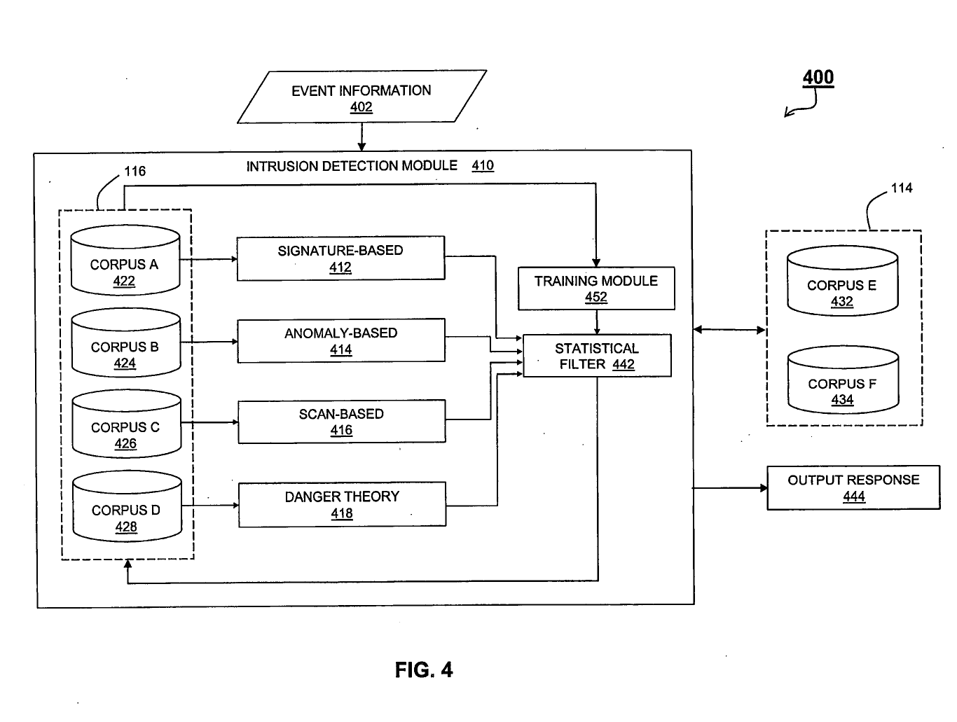

FIG. 4 is a block diagram illustrating an intrusion detection system 400 that may be implemented by one or more autonomic network nodes in accordance with an exemplary embodiment of the present invention. Intrusion detection system 400 generally comprises an intrusion detection (ID) module 410 that utilizes received system event data 402 to identify potentially malicious activity. Event data 402 may include, for example, information relating to files being accessed, ports being accessed, percentage of resource usage, etc. ID module 410 comprises multiple ID sub-modules each implementing a different ID technique. In the depicted example, the sub-modules included within ID module 410 include a signature-based ID module 412, an anomaly-based ID module 414, a scan-based ID module 416, and a danger theory ID module 418.

Each ID sub-module processes event data 402 to generate a result that is collectively processed with the results generated by the other sub-modules to produce a collective or consensus result. In the preferred embodiment shown in FIG. 4, a statistical filter module 442 is utilized to generate the collective result from the individual ID results from one or more of sub-modules 412, 414, 416, and 418. Specifically, statistical filter module 442 generates an effective “consensus” result by filtering the individual ID results generated by ID sub-modules 412, 414, 416, and 418 in accordance with statistical filtering techniques. In a preferred embodiment, filter module 442 is a Bayesian filter that employs well-known Bayesian statistical methods to classify the received event data 402 as either an intrusion or a non-intrusion in accordance with the individual results from sub-modules 412, 414, 416, and 418.

As is known in the art of statistical filtering, Bayesian filtering is a process of using Bayesian probability to classify information into one of several categories. Bayesian filters rely on the fact that particular patterns have different likelihoods of occurring across different categories. In the depicted example, Bayesian filtering involves maintaining multiple corpora containing individual ID results for each of ID sub-modules 412, 414, 416, and 418. In this respect, a corpus is a data storage container that holds detection information, such as signatures, complete knowledge of normal behavior, behavior of suspicious scans, and danger signals, reflecting ID results from the ID sub-modules, for example. Corpus A 422 may store signatures for signature-based intrusion analysis 412. Corpus B 424 may store a set of normal behaviors for anomaly-based intrusion analysis 414. Corpus C 426 may store what constitutes a suspicious scan for scan-based intrusion analysis 416. And, corpus D 428 may store danger signals for danger theory intrusion analysis 418. The information contained in corpus A 422, corpus B 424, corpus C 426, and corpus D 428 are collected and maintained from previous ID cycles and subsequently utilized by the respective ID sub-modules to identify future intrusions.

A Bayesian filter, such as may be implemented by statistical filter 442, must first be trained so it can determine the respective probabilities that event information having certain characteristics is either an intrusion or non-intrusion. To train filter 442, a user may manually indicate into which category particular information belongs, and the filter will then assign a probability to each input pattern. This probability indicates the likelihood that, in the absence of any other evidence, the information belongs in a particular category. When all of the evidence is taken together and a final probability is computed, the filter will assign a category to the information if it is considered extremely likely to belong to the category. The advantage of Bayesian filtering is that it can be trained on a per node basis. In the depicted embodiment adapted for use in an autonomic information system, a training module 452 is utilized to train statistical filter 442 in accordance with results from the individual corpora results.

For an initial ID determination, statistical filter 442 filters results from sub-modules 412, 414, 416, and 416 to produce a percentage score. The score may be, for example, a ratio E:F, where E is the likelihood that the activity is an intrusion and F is the likelihood that the activity is not an intrusion. If the score is at or above a threshold, then the activity is categorized as an intrusion. The corresponding event data is then stored in a collective intrusion corpus E 432 within intrusion database 114. If the score is below the threshold, the event data is categorized as a non-intrusion and stored in a collective safe corpus F 434 within intrusion database 114.

In the foregoing manner, corpus E 432 stores combinations of corpora A-D that constitute intrusions and corpus F 434 stores combinations of corpora A-D that do not constitute an intrusion. Therefore, given corpora A-D, corpus E 432 and corpus F 434 are updated and statistical filter 442 is trained over time so that intrusion detection system 400 educates and safeguards itself with respect to both known and unknown attacks. Subsequently, intrusion detection system 400 may make decisions based on corpus E 432 and corpus F 434 to take advantage of the strengths and avoid the weaknesses of the plurality of intrusion detection approaches.

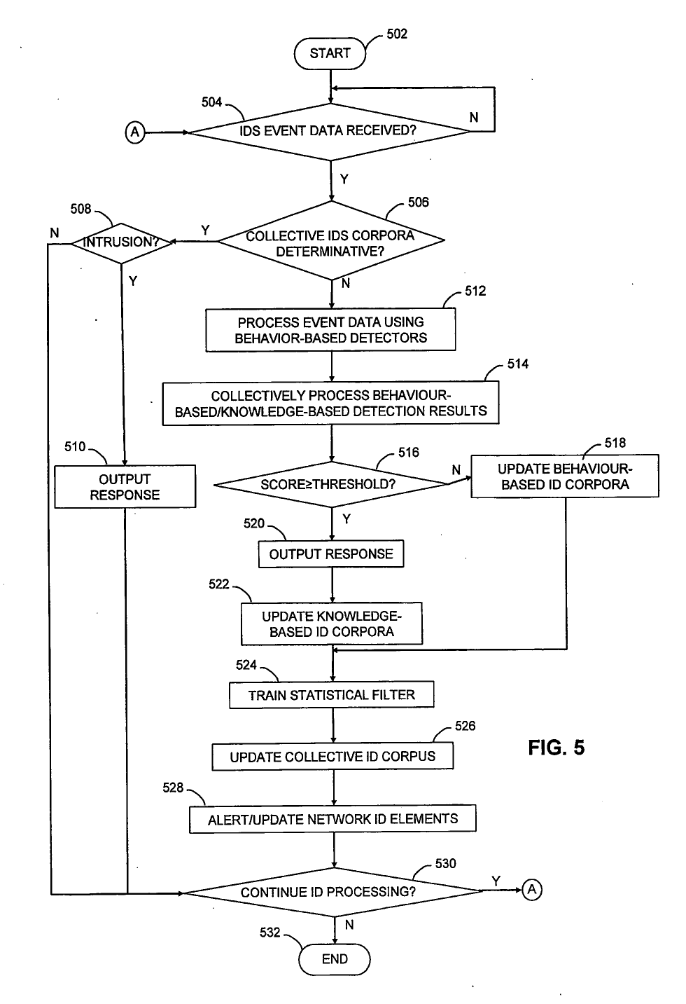

Referring to FIG. 5 in conjunction with FIG. 4, there is illustrated a flow diagram depicting steps performed by intrusion detection system 400 during adaptive intrusion detection within network data processing system 100 in accordance with the present invention. The process begins as shown at step 502 and proceeds to inquiry step 504 at which a determination is made of whether or not an ID-related system event signal or information has been received. As illustrated at step 506, responsive to an ID-related system event signal being received such as by ID module 410, the collective ID corpora, such as corpus E 432 and corpus F 434, are utilized to attempt to determine whether the event signal represents or otherwise indicates a system intrusion.

Responsive to a collective ID corpora determination that the event signal does not represent a system intrusion, ID module 410 continues ID processing as shown at steps 508 and 530. If the collective corpora assessment at step 506 is determinative, in accordance with a pre-specified threshold criterion, in identifying the received event signal as representing an intrusion, ID module 410 generates an output response 444 that addresses the detected intrusion on a station and network level before continuing with ID processing (steps 508, 510, and 530).

As shown at step 512, responsive to ID module 410 failing to determinatively categorize the received event data 402 as an intrusion or non-intrusion from the collective ID corpora, the process continues with ID module 410 processing the received system event data 402 using the various knowledge-based and behavior-based detection techniques implemented by sub-modules 412, 414, 416, and 418. Next, as depicted at step 514, statistical filter 442 is utilized to collectively process the knowledge-based and behavior-based detection results to generate a result in the form of a cumulative score. If, as shown at steps 516 and 518, the score is below a specified threshold, ID module 410 utilizes the received system event data 402 to update the ID corpora associated with behavior-based ID sub-modules among sub-modules 412, 414, 416, and 418. In the depicted embodiment, the behavior-based sub-modules include anomaly-based sub-module 414 and danger theory sub-module 418. Therefore, corpora B 424 and D 428 would be updated as illustrated at step 518.

If, as shown at steps 516, 520, and 522 the score is at or above the specified threshold, ID module 410 generates output response 444 and updates the ID corpora associated with knowledge-based ID sub-modules among sub-modules 412, 414, 416, and 418. In the depicted embodiment, the knowledge-based sub-modules include signature-based sub-module 412 and scan-based sub-module 416. Therefore, corpora A 422 and C 426 would be updated as illustrated at step 522. Following updates to either the knowledge-based corpora (step 522) or behavior-based corpora (step 518), training module 452 trains statistical filter 442 using the updates as shown at step 524.

As a further response to processing of the received system event information shown at steps 512, 514, and 516, the intrusion database 114, containing collective intrusion corpus 432 and collective safe corpus 434 is also updated as illustrated at step 526. Furthermore, ID module 410 issues a network alert or notification of the update status of containing collective intrusion corpus 432 and/or collective safe corpus 434 to the other nodes within network data processing system 100 (step 528). In this manner, the updates to the collective ID corpora within intrusion database 114 may be sent to or retrieved by one or more of the other nodes to update the respective local ID corpora and utilized for local intrusion detection. Any additional node that is added to the network, either in a permanent configuration or temporarily for the sole purpose of ID data sharing, automatically receives the updated ID corpora data and incorporates the same into its local ID corpora. Furthermore, and in association with the update step 528, the present invention further encompasses node-specific ID update profiles. Namely, one or more of the nodes may have a profile configured to take pre-specified defensive actions until the ID data updates are actually received. For example, a node may be configured to restrict incoming network traffic following an ID detection alert and before the node receives the ID data updates. In such a case, the node may delegate its present network traffic handling responsibilities to an already updated node pending receipt of the ID updates. The intrusion detection and update process continues as shown at step 530 until it terminates at step 532.

With reference to step 528, it should be noted that the updating of the network nodes may not be performed simultaneously or in parallel in response to an intrusion detection alert. In an embodiment in which the updating of the nodes is sequential, each node that has been updated may assist in updating other nodes. This may be implemented by a peer-to-peer data exchange technique such as the emerging BitTorrent® data sharing technique. BitTorrent® is a client application for the torrent peer-to-peer (P2P) file distribution protocol. BitTorrent® is designed to widely distribute large amounts of data without incurring the corresponding consumption in server and bandwidth resources. The BitTorrent® protocol breaks the file(s) down into smaller fragments, typically 256 KB. Peer nodes download missing fragments from other peers and upload those that they already have to requesting peers. The protocol enables selection of the node having optimal network connections for the particular fragments that the node requesting. To improve overall data transfer efficiency of the peer-to-peer network, the nodes request from their peers the least available fragments, making most fragments available widely across many machines and avoiding bottlenecks.

In the foregoing manner, the present invention enables autonomic network elements to share ID data, allowing elements to react more quickly and with greater accuracy to intrusions that have not been previously encountered. By providing means for collecting and disseminating ID data the invention allows elements perform intrusion detection cooperatively instead of individually, significantly reducing the incidence of duplicate ID processing and also reducing the number of elements successfully attacked by a malicious intruder.

The disclosed methods may be readily implemented in software using object or object-oriented software development environments that provide portable source code that can be used on a variety of computer or workstation hardware platforms. In this instance, the methods and systems of the invention can be implemented as a routine embedded on a personal computer such as a Java or CGI script, as a resource residing on a server or graphics workstation, as a routine embedded in a dedicated source code editor management system, or the like.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A method for adaptively identifying unauthorized intrusions in a networked data processing system, said method comprising:
receiving system event data;
processing the system event data utilizing at least one behavior-based intrusion detection technique to generate an intrusion detection result; and
responsive to the intrusion detection result indicating an unauthorized intrusion, updating at least one knowledge-based intrusion detection corpus utilizing the system event data.

2. The method of claim 1, wherein the knowledge-based intrusion detection corpus is communicatively accessible by multiple elements coupled to the networked data processing system, said method further comprising issuing a network update to update knowledge-based intrusion detection corpora associated with said multiple elements.

3. The method of claim 1, said processing the system event data utilizing at least one behavior-based intrusion detection technique further comprising collectively processing the received system event data utilizing multiple intrusion detection techniques.

4. The method of claim 3, wherein said multiple intrusion detection techniques are selected from the group comprising:
anomaly-based intrusion detection techniques;
signature-based intrusion detection techniques;
scan-based intrusion detection techniques; and
danger theory intrusion detection techniques.

5. The method of claim 3, further comprising, responsive to the intrusion detection result indicating a non-intrusion, updating at least one behavior-based detection corpus to identify the system event data as representing a non-intrusion.

6. The method of claim 3, wherein said collectively processing the received system event data utilizing multiple intrusion detection techniques comprises statistically filtering intrusion detection results from multiple intrusion detection modules.

7. The method of claim 6, wherein said statistical filtering comprises Bayesian filtering.

8. An intrusion detection system that adaptively identifies unauthorized intrusions in a networked data processing system, said intrusion detection system comprising:
computer processing means for receiving system event data;
computer processing means for processing the system event data utilizing at least one behavior-based intrusion detection technique to generate an intrusion detection result; and
computer processing means, responsive to the intrusion detection result indicating an unauthorized intrusion, for updating at least one knowledge-based intrusion detection corpus utilizing the system event data.

9. The intrusion detection system of claim 8, wherein the knowledge-based intrusion detection corpus is communicatively accessible by multiple elements coupled to the networked data processing system, said intrusion detection system further comprising computer processing means for issuing a network update to update knowledge-based intrusion detection corpora associated with said multiple elements.

10. The intrusion detection system of claim 8, said computer processing means for processing the system event data utilizing at least one behavior-based intrusion detection technique further comprising computer processing means for collectively processing the received system event data utilizing multiple intrusion detection techniques.

11. The intrusion detection system of claim 10, wherein said multiple intrusion detection techniques are selected from the group comprising:
anomaly-based intrusion detection techniques;
signature-based intrusion detection techniques;
scan-based intrusion detection techniques; and
danger theory intrusion detection techniques.

12. The intrusion detection system of claim 10, further comprising computer processing means, responsive to the intrusion detection result indicating a non-intrusion, for updating at least one behavior-based detection corpus to identify the system event data as representing a non-intrusion.

13. The intrusion detection system of claim 10, wherein said computer processing means for collectively processing the received system event data utilizing multiple intrusion detection techniques comprises a statistical filter for statistically filtering intrusion detection results from multiple intrusion detection modules.

14. The intrusion detection system of claim 13, wherein said statistical filter comprises a Bayesian filter.

15. A computer-readable medium having stored thereon computer-executable instructions for adaptively identifying unauthorized intrusions in a networked data processing system, said computer-executable instructions performing a method comprising:
receiving system event data;
processing the system event data utilizing at least one behavior-based intrusion detection technique to generate an intrusion detection result; and
responsive to the intrusion detection result indicating an unauthorized intrusion, updating at least one knowledge-based intrusion detection corpus utilizing the system event data.

16. The computer-readable medium of claim 15, wherein the knowledge-based intrusion detection corpus is communicatively accessible by multiple elements coupled to the networked data processing system, said method further comprising issuing a network update to update knowledge-based intrusion detection corpora associated with said multiple elements.

17. The computer-readable medium of claim 15, said processing the system event data utilizing at least one behavior-based intrusion detection technique further comprising collectively processing the received system event data utilizing multiple intrusion detection techniques.

18. The computer-readable medium of claim 17, wherein said multiple intrusion detection techniques are selected from the group comprising:
anomaly-based intrusion detection techniques;
signature-based intrusion detection techniques;
scan-based intrusion detection techniques; and
danger theory intrusion detection techniques.

19. The computer-readable medium of claim 17, further comprising, responsive to the intrusion detection result indicating a non-intrusion, updating at least one behavior-based detection corpus to identify the system event data as representing a non-intrusion.

20. The computer-readable medium of claim 17, wherein said collectively processing the received system event data utilizing multiple intrusion detection techniques comprises statistically filtering intrusion detection results from multiple intrusion detection modules.
